(19) United States
(12) Patent Application Publication
(10) Pub. No.: US 2005/0285013 A1
(43) Pub. Date: Dec. 29, 2005

(54) Office equipment assembly

(76) Inventor: Tsachi Davidov, Neve Monson (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 11/157,937

(22) Filed: Jun. 22, 2005

Related U.S. Application Data
(60) Provisional application No. 60/582,795, filed on Jun. 28, 2004.

(51) Int. Cl. G11B 23/03; A47G 29/00

(52) U.S. Cl. 248/683

(57) ABSTRACT

An office equipment assembly including an office equipment item with a magnetic element on an outer surface thereof, the magnetic element having sufficient magnetic strength for supporting a full weight of the office equipment item when the magnetic element is magnetically affixed to a vertical magnetic surface.

### FIELD OF THE INVENTION

The present invention relates generally to office equipment assemblies and particularly to modular office equipment assemblies.

### BACKGROUND OF THE INVENTION

Many types of office equipment are known and available, such as paper holders, staplers, stapler removers, hole punchers, tape dispensers, organizers, trays and the like.

In general, office equipment is purchased as separate items and placed at different places in a work area. Office equipment is generally placed on top of a work table or on shelves, for example.

### SUMMARY OF THE INVENTION

The present invention seeks to provide novel office equipment assemblies with magnetic elements for mounting to (e.g., vertical) magnetic surfaces. Moreover, the present invention seeks to provide novel modular office equipment assemblies, which may be connected to one another and/or other modular construction elements, and which are compatible with one another. The assemblies of the invention may provide mounting and storage capabilities for office equipment heretofore not possible with conventional office equipment.

The modular office equipment assemblies may include mounting studs that may be inserted into corresponding mounting sockets. Alternatively or additionally, the modular office equipment assemblies may be assembled together with magnetic elements or connectors.

There is thus provided in accordance with an embodiment of the present invention an office equipment assembly including an office equipment item with a magnetic element on an outer surface thereof, the magnetic element having sufficient magnetic strength for supporting a full weight of the office equipment item when the magnetic element is magnetically affixed to a vertical magnetic surface. The office equipment item may further include a plurality of mounting studs and mounting sockets, wherein the mounting studs of one such office equipment item are insertable into corresponding mounting sockets of another such office equipment item. The magnetic elements may be the mounting studs (or a part thereof) or may be part of the mounting sockets.

There is also provided in accordance with an embodiment of the present invention an office equipment assembly including a kit that includes two or more office equipment items each with a magnetic element on an outer surface thereof, the two or more office equipment items being different in shape and function from each other, wherein the magnetic element has sufficient magnetic strength for supporting a full weight of the office equipment item when the magnetic element is magnetically affixed to a vertical magnetic surface.

### BRIEF DESCRIPTION OF THE DRAWINGS

The present invention will be understood and appreciated more fully from the following detailed description taken in conjunction with the appended drawings, which illustrate different embodiments of office equipment constructed in accordance with different embodiments of the present invention, in which:

FIG. 1 is a simplified illustration of a paper tray constructed and operative in accordance with an embodiment of the present invention;

FIGS. 2A and 2B are simplified illustrations of a tape dispenser constructed and operative in accordance with an embodiment of the present invention;

FIG. 3 is a simplified illustration of a stapler constructed and operative in accordance with an embodiment of the present invention;

FIG. 4 is a simplified illustration of a staple remover constructed and operative in accordance with an embodiment of the present invention;

FIG. 5 is a simplified illustration of a personal computer (PC) screen device, e.g., for holding other office equipment products, constructed and operative in accordance with an embodiment of the present invention;

FIG. 6 is a simplified illustration of a pen case constructed and operative in accordance with an embodiment of the present invention;

FIG. 7 is a simplified illustration of a pencil sharpener constructed and operative in accordance with an embodiment of the present invention;

FIG. 8 is a simplified illustration of a business or memo card holder constructed and operative in accordance with an embodiment of the present invention;

FIG. 9 is a simplified illustration of an organizer constructed and operative in accordance with an embodiment of the present invention;

FIG. 10 is a simplified illustration of an inked stamp constructed and operative in accordance with an embodiment of the present invention;

FIG. 11 is a simplified illustration of a paper punch constructed and operative in accordance with an embodiment of the present invention;

FIG. 12 is a simplified illustration of a scissors holder constructed and operative in accordance with an embodiment of the present invention;

FIG. 13 is a simplified illustration of a writing utensil holder (pen and pencil holder) constructed and operative in accordance with an embodiment of the present invention; and

FIG. 14 is a simplified illustration of a writing utensil holder (pen holder) constructed and operative in accordance with an embodiment of the present invention.

### DETAILED DESCRIPTION OF THE PRESENT INVENTION

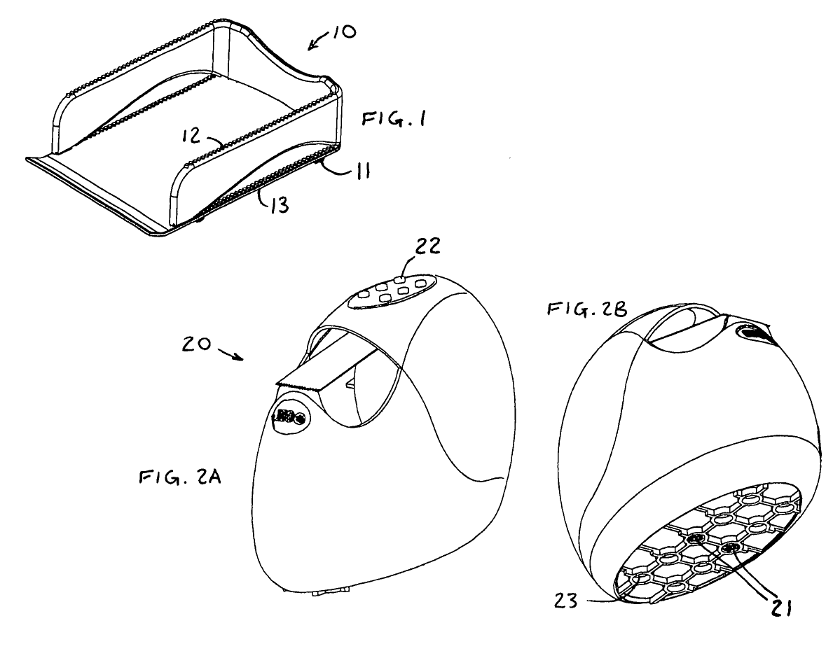

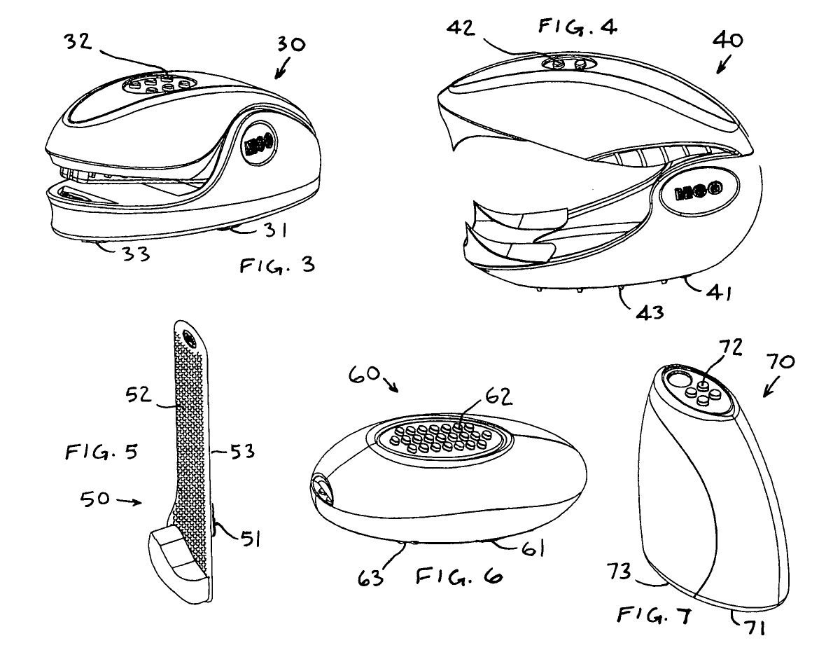

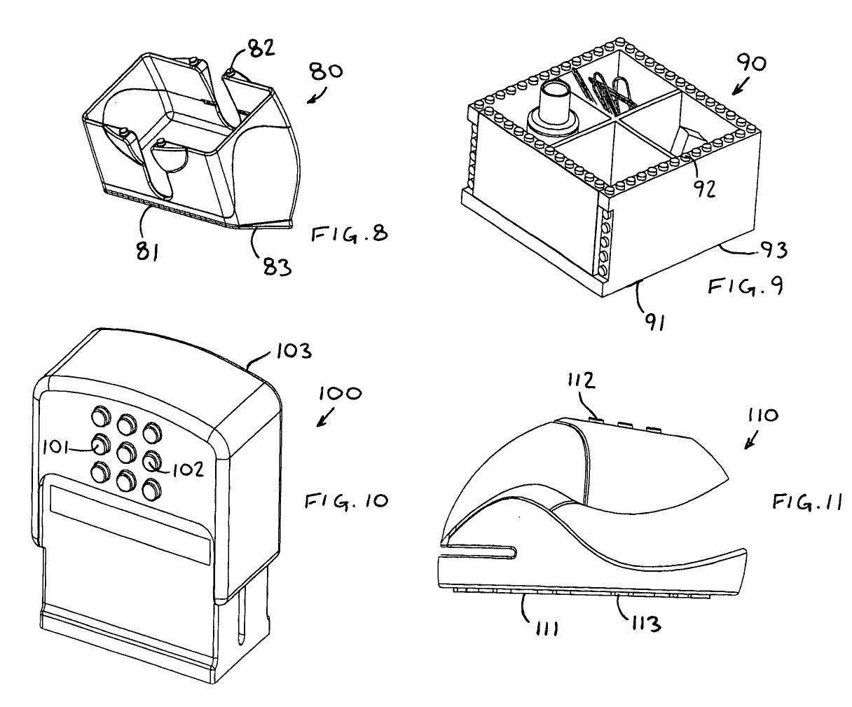

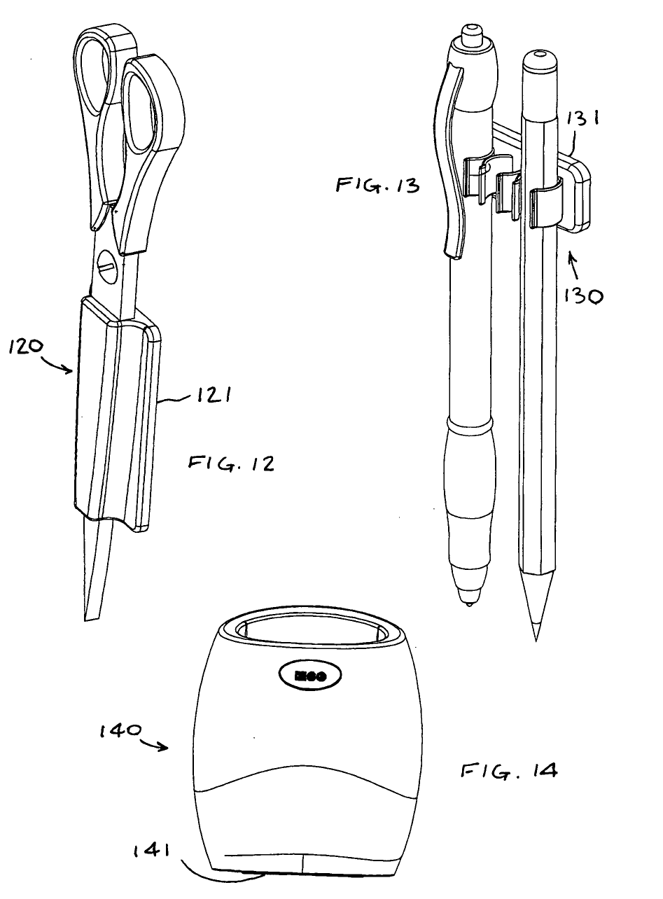

FIGS. 1-14 illustrate office equipment assemblies and items in accordance with embodiments of the present invention. In all of the embodiments, the office equipment item includes a magnetic element on an outer surface thereof. The magnetic element has sufficient magnetic strength for supporting the full weight of the office equipment item when the magnetic element is magnetically affixed to a vertical magnetic surface. The office equipment item may further include a plurality of mounting studs and mounting sockets, wherein the mounting studs of one such office equipment item are insertable into corresponding mounting sockets of another such office equipment item. Examples of such embodiments are now described.

Reference is now made to FIG. 1, which illustrates a paper tray 10 constructed and operative in accordance with an embodiment of the present invention. The paper tray 10 may include magnetic elements 11 on an underside thereof, and alternatively a plurality of mounting studs 12 that may be inserted into corresponding mounting sockets 13. The studs may be formed on an upper side of the tray or sidewalls of the tray, and the sockets may be formed on the lower side of the tray, as shown. Conversely, the studs may be on the lower side and the sockets may be formed on the upper side.

Reference is now made to FIGS. 2A and 2B, which illustrate a tape dispenser 20 constructed and operative in accordance with an embodiment of the present invention. The tape dispenser 20 may include magnetic elements 21 on an underside thereof, and alternatively a plurality of mounting studs 22 that may be inserted into corresponding mounting sockets 23. As mentioned similarly above, the studs may be formed on an upper side of the tape dispenser, and the sockets may be formed on the lower side of the tape dispenser, as shown. Conversely, the studs may be on the lower side and the sockets may be formed on the upper side.

Reference is now made to FIG. 3, which illustrates a stapler 30 constructed and operative in accordance with an embodiment of the present invention. The stapler 30 may include magnetic elements 31 on an underside thereof, and alternatively a plurality of mounting studs 32 that may be inserted into corresponding mounting sockets 33.

Reference is now made to FIG. 4, which illustrates a staple remover 40 constructed and operative in accordance with an embodiment of the present invention. The staple remover 40 may include magnetic elements 41 on an underside thereof, and alternatively a plurality of mounting studs 42 that may be inserted into corresponding mounting sockets 43.

Reference is now made to FIG. 5, which illustrates a personal computer (PC) screen device 50, e.g., for holding other office equipment products, constructed and operative in accordance with an embodiment of the present invention. The PC screen device 50 may include magnetic elements 51 on a rear side thereof, and alternatively a plurality of mounting studs 52 that may be inserted into corresponding mounting sockets 53.

Reference is now made to FIG. 6, which illustrates a pen case 60 constructed and operative in accordance with an embodiment of the present invention. The pen case 60 may include magnetic elements 61 on an underside thereof, and alternatively a plurality of mounting studs 62 that may be inserted into corresponding mounting sockets 63.

Reference is now made to FIG. 7, which illustrates a pencil sharpener 70 constructed and operative in accordance with an embodiment of the present invention. The pencil sharpener 70 may include magnetic elements 71 on an underside thereof, and alternatively a plurality of mounting studs 72 that may be inserted into corresponding mounting sockets 73.

Reference is now made to FIG. 8, which illustrates a card holder 80 (business or memo cards, for example) constructed and operative in accordance with an embodiment of the present invention. The business card holder 80 may include magnetic elements 81 on an underside thereof, and alternatively a plurality of mounting studs 82 that may be inserted into corresponding mounting sockets 83.

Reference is now made to FIG. 9, which illustrates an organizer 90 constructed and operative in accordance with an embodiment of the present invention. The organizer 90 may include magnetic elements 91 on an underside thereof, and alternatively a plurality of mounting studs 92 that may be inserted into corresponding mounting sockets 93.

Reference is now made to FIG. 10, which illustrates an inked stamp 100 constructed and operative in accordance with an embodiment of the present invention. The stamp 100 may include magnetic elements 101 on a front side thereof, and alternatively a plurality of mounting studs 102 that may be inserted into corresponding mounting sockets 103.

Reference is now made to FIG. 11, which illustrates a paper punch 110 constructed and operative in accordance with an embodiment of the present invention. The paper punch 110 may include magnetic elements 111 on an underside thereof, and alternatively a plurality of mounting studs 112 that may be inserted into corresponding mounting sockets 113.

Reference is now made to FIG. 12, which illustrates a scissors holder 120 constructed and operative in accordance with an embodiment of the present invention. The scissors holder 120 may include magnetic elements 121 on a rear side thereof.

Reference is now made to FIG. 13, which illustrates a writing utensil holder 130 (e.g., a pen and pencil holder) constructed and operative in accordance with an embodiment of the present invention. The pen and pencil holder may include magnetic elements 131 on a rear side thereof.

Reference is now made to FIG. 14, which illustrates another writing utensil holder 140 (e.g., a pen holder) constructed and operative in accordance with an embodiment of the present invention. The pen holder may include magnetic elements 141 on an underside thereof.

Alternatively or additionally, any of the above embodiments of the modular office equipment assemblies may be assembled together with magnetic elements or connectors.

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

1. An office equipment assembly comprising:
an office equipment item with a magnetic element on an outer surface thereof, the magnetic element having sufficient magnetic strength for supporting a full weight of said office equipment item when said magnetic element is magnetically affixed to a vertical magnetic surface.

2. The office equipment assembly according to claim 1, wherein said office equipment item further comprises a plurality of mounting studs and mounting sockets, wherein said mounting studs of one such office equipment item are insertable into corresponding mounting sockets of another such office equipment item.

3. The office equipment assembly according to claim 2, wherein said mounting studs and mounting sockets are formed on upper and lower sides of said office equipment item.

4. The office equipment assembly according to claim 1, wherein said office equipment item comprises at least one of a stapler and a staple remover.

5. The office equipment assembly according to claim 1, wherein said office equipment item comprises at least one of a pencil sharpener and a writing utensil holder.

6. The office equipment assembly according to claim 1, wherein said office equipment item comprises at least one of a paper tray, a tape dispenser, a stapler, a staple remover, a PC screen device, a pen case, a pencil sharpener, a card holder, an organizer, an inked stamp, a paper punch, a scissors holder, a pen and pencil holder, and a pen holder.

7. The office equipment assembly according to claim 2, wherein said magnetic element comprises at least one of said mounting studs and said mounting sockets.

8. An office equipment assembly comprising:
a kit that includes two or more office equipment items each with a magnetic element on an outer surface thereof, the two or more office equipment items being different in shape and function from each other, wherein the magnetic element has sufficient magnetic strength for supporting a full weight of said office equipment item when said magnetic element is magnetically affixed to a vertical magnetic surface.

9. The office equipment assembly according to claim 8, wherein each said office equipment item further comprises a plurality of mounting studs and mounting sockets, wherein said mounting studs of one such office equipment item are insertable into corresponding mounting sockets of another such office equipment item.

10. The office equipment assembly according to claim 9, wherein said mounting studs and mounting sockets are formed on upper and lower sides of said office equipment item.

11. The office equipment assembly according to claim 8, wherein said two or more office equipment items comprise a stapler and a staple remover.

12. The office equipment assembly according to claim 8, wherein said two or more office equipment items comprises a pencil sharpener and a writing utensil holder.

13. The office equipment assembly according to claim 8, wherein said two or more office equipment item comprises at least two or more of a paper tray, a tape dispenser, a stapler, a staple remover, a PC screen device, a pen case, a pencil sharpener, a card holder, an organizer, an inked stamp, a paper punch, a scissors holder, a pen and pencil holder, and a pen holder.

14. The office equipment assembly according to claim 9, wherein said magnetic element comprises at least one of said mounting studs and said mounting sockets.
